(19) United States
(12) Patent Application Publication
(10) Pub. No.: US 2009/0139602 A1
(43) Pub. Date: Jun. 4, 2009

(54) Tool and Method for Splaying Strands of Wire Rope Ends

(76) Inventor: Henry A. Kwasny, Waseca (CA)

Correspondence Address: ADE & COMPANY INC., 2157 Henderson Highway, WINNIPEG, MB, R2G1P9, CA

(21) Appl. No.: 11/947,015

(22) Filed: Nov. 29, 2007

(51) Int. Cl. B21F 1/00; B25B 27/00

(52) U.S. Cl. 140/123; 81/485

(57) ABSTRACT

A tool and a method are provided for splaying strands of a wire rope at an end thereof. The tool features a body defining a central opening and a plurality of outer openings extending into the body from a common side thereof, the openings sized and positioned for receipt of end portions of the strands at the end of the wire rope. The outer openings are arranged for splaying of the strands of the rope outward away from the core thereof under rotation of the body in a first direction about the core with the strands received in the openings. The rotation untwists the strands from around the core while the openings are shaped to limit motion of the untwisted ends of the strands to sliding motion along guiding surfaces outward away from the core.

### FIELD OF THE INVENTION

This invention relates generally to wire rope or cable and more particularly to a tool and method for splaying strands of a wire rope or cable outward from a core thereof at an end of the wire rope or cable.

### BACKGROUND OF THE INVENTION

It has long been known within the art to equip an end of a wire cable or rope with a frustoconical wedge fitted about a core of the wire rope between the core and the strands helically wrapped thereabout after having splayed the strands outward away from the core at the end of the rope, so that a similarly tapered bore of another body can be fitted over the wedge and the splayed ends spaced thereabout to effectively clamp the ends of the strands between the external walls of the wedge and the internal walls of the other body, thereby securing the bore-equipped body to the rope at the end thereof. Such securing of a bell sleeve, socket, stop, hook or other body is utilized in a variety of fields where cable or wire rope is used, including oil field applications, logging, mining, farming and transportation, such as in the use of a winch tractor.

For example, such a fastening means is disclosed in U.S. Pat. No. 4,055,365 of Kucherry for a chocker assembly of a dragline or winchline extended out from a landing or towing vehicle for dragging of cut logs to a landing area.

However, splaying of the strands of the wire rope outward from the core in order fit the wedge into the rope end may be difficult and time consuming, which, for example, may potentially lead to significant delay on the job in situations where on-site need for wire rope repair or replacement is necessary or desirable.

Although the detailed embodiments of the present invention are presented in the context of preparing a wire rope end to receive a wedge for cooperation with the tapered bore of a body to be secured to the rope, it should be appreciated that the tools and methods taught herein below for splaying the outer strands of a wire rope may be similarly applied for other purposes where such splaying is similarly desirable. For example, it is known within the art to apply molten material into the splayed end of a wire rope and allow it to harden to retain the tapered stop-defining shape at the end of the rope. The aforementioned use of a preformed wedge is an alternative to this approach, the wedge advantageously allowing formation of the tapered rope end in situations for molten material is not readily available or preparable, for example to form a connection on a new cable or form a new end connection on a broken cable at a remote job site.

### SUMMARY OF THE INVENTION

According to a first aspect of the invention there is provided a tool for splaying strands of a wire rope at an end thereof outward away from a core of the rope about which the strands are disposed, the tool comprising:

a body defining a central opening and a plurality of outer openings extending into the body from a common side thereof, the central opening and the plurality of outer openings being sized and positioned for receipt of end portions of the central and strands at the end of the wire rope from the common side of the body, the outer openings each having an elongate shape extending outward away from the central opening along the common side of the body from an inner end to an outer end.

Preferably the elongate shapes of the outer openings along the common side of the body deviate from radial directions relative to the central opening to situate the outer end of each outer opening ahead of the inner end thereof in a common direction about the central opening.

Preferably the elongate shape of each outer opening extending between the inner and outer ends thereof is curved.

Preferably each outer opening is smoothly curved from the inner end of the outer opening to the inner end thereof.

Preferably sides of the elongate shape of each outer opening extending between the inner and outer ends thereof are concave to the common direction about the central opening.

Preferably the body is solid between the openings along the common side of the body.

Preferably at least one of the openings is defined by a respective recess extending only partially through the body from the common side thereof.

Preferably the outer openings are each defined by a respective recess extending only partially through the body from the common side thereof.

Preferably there is provided a handle projecting from the body along the common side thereof to define a lever by which the body can be rotated about the central opening.

Preferably the outer ends of the outer openings are equally spaced about the central opening.

Preferably the outer openings are each radially spaced from the central opening along the common side of the tool body by an equal amount.

The outer openings may consist of six openings equally spaced about the central opening.

According to a second aspect of the invention there is provided a tool for splaying strands of a wire rope at an end thereof outward away from a core of the rope about which the strands are disposed, the tool comprising:

a body defining a central opening and a plurality of outer openings extending into the body from a common side thereof, the central opening and the plurality of outer openings being sized and positioned for receipt of end portions of the central and strands at the end of the wire rope from the common side of the body;

the outer openings being arranged for splaying of the strands of the rope outward away from the core thereof at the end of the wire rope under rotation of the body in a first direction about the core at the end of the wire rope subsequent to receipt of the core and the strands in the central and outer openings respectively.

Preferably the outer openings are also arranged for directing the strands of the rope inward back toward the core thereof under rotation of the body in a second direction, opposite the first direction, about the core at the end of the wire rope subsequent to splaying of the strands.

According to a third aspect of the invention there is provided a method for splaying strands of a wire rope at an end thereof outward away from a core of the rope about which the strands are disposed, the method comprising simultaneously untwisting the strands from about the core in a first direction while forcing the strands outward away from the core at the end of the wire rope.

Preferably the method comprises sliding the strands along guide surfaces shaped and positioned to force each strand away from the core at the end of the wire rope under untwisting of the strands from about the core in the first direction.

There may be provided the additional step of releasing the strands and inserting a wedge into the end of the rope over the core into space formed between the core and the strands during the twisting and forcing outward of the strands, in which case there may be provided yet a further step of simultaneously twisting the strands about the core in a second direction opposite the first direction while forcing the strands inward back toward the core at the end of the wire rope.

### BRIEF DESCRIPTION OF THE DRAWINGS

In the accompanying drawings, which are not to scale and which illustrate an exemplary embodiment of the present invention:

FIGS. 1A and 1B are top and bottom plan views respectively of a tool for splaying strands of a wire rope at an end thereof.

FIG. 2 is a cross sectional view of the tool of FIG. 1B as taken along line II-II thereof.

FIGS. 3A, 3B and 3C are top plan, bottom plan and side elevational views respectively of a bell sleeve arranged to have the wire rope passed therethrough for subsequent splaying of the wire rope strands and clamping of the splayed strands between tapered inner surfaces of the bell sleeve and a wedge inserted into the end of the rope to fasten the bell sleeve to the rope.

FIG. 4 is a perspective view of the wedge arranged for fitting into the end of the wire rope between the core thereof and the strands splayed outward therefrom.

FIG. 5 is a cross sectional view of the bell sleeve and the wedge cooperatively installed on the splayed end of the wire rope.

### DETAILED DESCRIPTION

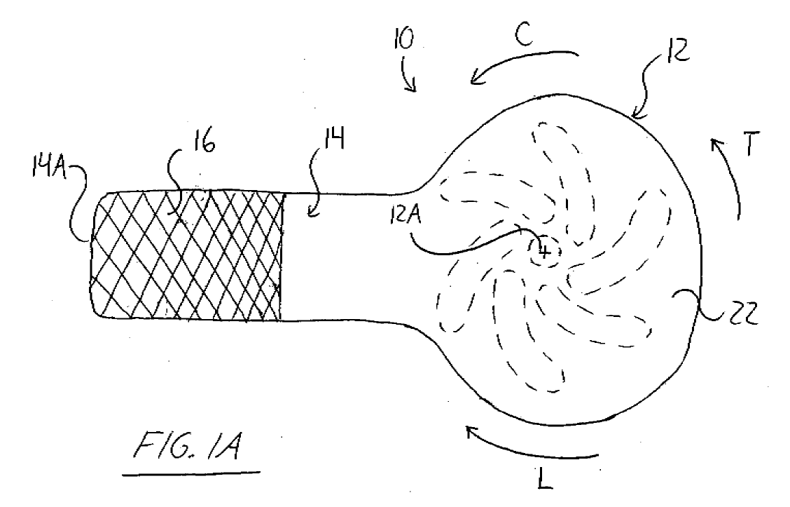

As shown in FIG. 1A, one embodiment of a tool 10 for splaying the strands of a wire rope outward from the core of the rope at an end thereof features a solid cylindrical metal body 12 of circular cross section with an integral elongate handle 14 projecting radially outward from the cylindrical body 12. The handle 14 defines a lever by which the tool body 12 can be manually pivoted about the central axis 12A of the cylindrical body 12. As shown, the handle 14 may be knurled or otherwise modified or equipped to define a gripping surface 16 proximate a distal end 14A of the handle opposite the tool body 12.

As shown in FIG. 1B, a working face 18 of the tool is defined by one of the two flat end faces of the cylindrical body 12. A central recess 20 extends into the cylindrical body 12 along the central longitudinal axis 12A thereof from the working face 18, but does not extend fully through the body 12 to the opposite end face 22 thereof. The central recess 20 is cylindrical with a circular cross section sized according to the diameter of a wire rope's core to allow receipt of an end thereof within the central recess from the side of the tool 10 faced by the working face 18.

A plurality of slots S1-S6 are angularly spaced about the central recess 20, similarly recessed into the tool body 12 from the working face 18 thereof to extend only partially therethrough. The slots S1-S6 are also cylindrical, but are not circular in cross section. Instead, each slot has an elongate shape along the working face 18 and planes parallel thereto, perpendicular to the body's longitudinal axis 12A at positions therealong. The slots S1-S6 feature inner end portions S1i-S6i radially equidistant from the body's central axis 12A and the central recess 20 extending therealong and equally angularly spaced thereabout. The slots S1-S6 extend outward away from the central axis 12A and central recess 20 along the working face 18 to outer end portions S1o-S6o, but not in a radial fashion. Instead, each slot deviates from a radial direction, curving forward about central axis 12A and central recess 20 in the same common direction as the rest of the slots. Each slot thus has its outer end situated ahead of its inner end in this common direction about the central axis 12A and central recess 20, the common direction C being clockwise when facing the working face 18 in the illustrated embodiment. The elongate shape of each slot is rounded at both ends with a width of the slot remaining substantially constant along the slot between its opposite rounded ends. The width of the slots is chosen based on the diameter of the strands of the wire rope, such that the strands helically wrapped about the rope's core can have their ends fitted into the slots S1-S6 from the side of the tool to which the slots open at the working face 18.

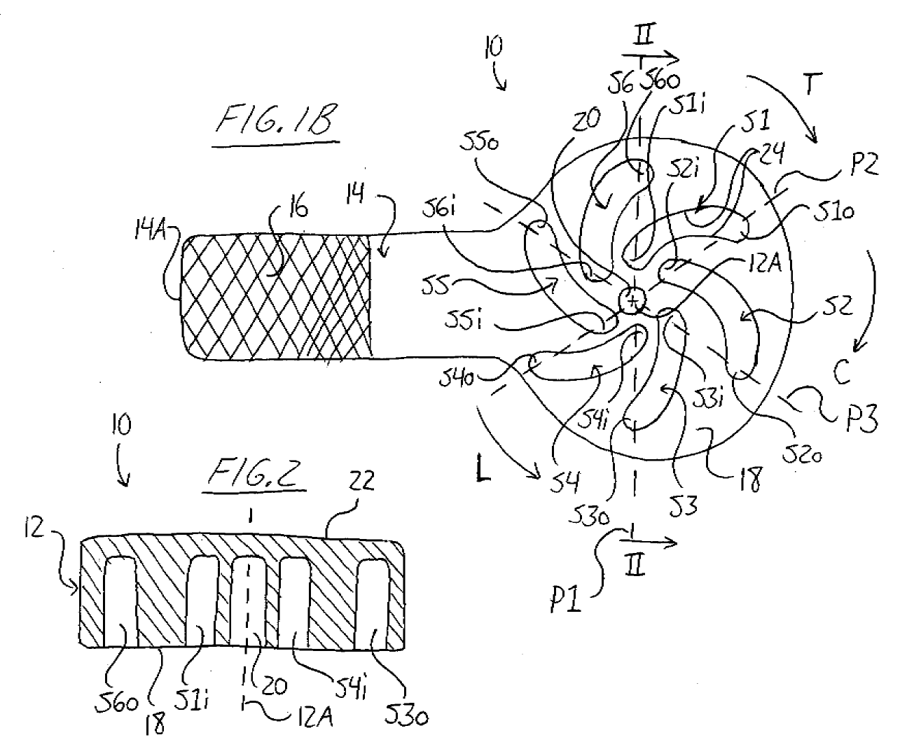

Each slot is curved in the longitudinal direction of its cross sectional shape to define opposite curved sides 24, in generally concentric arcuate arrangement with one another, extending between the slot's opposite rounded ends. The curve of each slot is such that its sides 24 are concavely facing the common direction C about the central axis 12A and central recess 20 in which the outer end portions S1o-S6o of the slots S1-S6 are leading the inner end portions S1i-S6i. Like the inner end portions S1i-S6i of the slots S1-S6, the outer end portions S1o-S6o are all situated at the same radial distance from the central axis 12A and the central recess 20 along the working face 18, and are equally spaced from one another angularly about the central axis 12A and central recess 20 of the cylindrical body 12. Moving outward away from the central recess 20, each slot curves past the inner end of an adjacent slot, the outer end portion of each slot angularly aligning about the central axis 12A and the central recess 20 with the inner end portion of the next slot thereabout in the common direction. If each end portion of the slots is considered to be a cylindrical volume of circular cross section extending normally into the tool body 12 from the working face 18 with a diameter slightly exceeding that of the strands of a wire rope on which the tool is to be used, a radial plane projecting from the common central longitudinal axis 12A of the central recess 20 and the tool body 12 thus cuts diametrically through four slot end portions, one outer end portion and one inner end portion on each side of the central axis. This is illustrated in FIG. 2, in which the tool body 12 has been cut along such a radial plane, as represented by line 11-11 in FIG. 1B, the cross section passing through outer end portion S6o of slot S6, inner end portion S1i of slot S1, outer end portion S3o of slot S3 and inner end portion S4i of slot S4.

In the illustrated embodiment of the tool, six slots S1-S6 are spaced apart around the central recess 20, corresponding to a six strand wire rope, commonly used in many applications and featuring six strands helically coiled around a central core. The aforementioned equal angularly spacing between inner ends and between outer ends around the central axis 12A is thus sixty degrees in the illustrated embodiment, as illustrated by equally spaced radial planes P1, P2 and P3 in FIG. 1B. The overlapping angular positions of the opposite end portions of adjacent slots in the illustrated embodiment thus also corresponds to each slot spanning a sixty degree segment of the cylindrical body. From the following description however, it should be apparent that the number of slots positioned around the central opening may be varied for use with other wire ropes featuring different strand numbers.

The tool 10 is used by inserting the end of a wire rope into the recesses of the tool body 12 from the side thereof faced by the working face 18, specifically to insert the end of the wire rope's core into the central recess 20 in the tool body 12 and the ends of the strands helically wrapped around the core into the inner end portions S1i-S6i of the slot-like recess S1-S6 from the open ends of the recesses 20, S1-S6 at the working face 18. Due to the size of radial spacing between the central recess 20 and the slot recess S1-S6 in the illustrated embodiment of the tool, the strands of the wire rope are first pried or unwound slightly from the core, for example after sliding an outer sleeve of a bell over the end of the wire rope during use of the tool in a bell installation, before placing the tool over the end of the rope so that the strands will fit into the slots. In alternative embodiments, if the radial spacing between the central recess and the surrounding slot-like recesses is formed of a sufficiently narrow portion of solid rigid material, it may be possible for this portion to wedge itself between the wire rope's core and strands simply by forcing the tool onto the end of the wire rope. With the end of the wire rope having been so inserted into the recesses of the tool body, for example by lowering the tool body onto the end of the rope with the working face directed theretoward, the handle 14 is then used to effect pivotal motion of the tool about the central recess 20 and the core of the wire rope disposed therein in a direction L opposite that of the common direction C in which the outer end of each slot-like recess S1-S6 leads the inner end thereof. This pivoting of the tool 10, in a counter-clockwise direction when viewing the working face 18 of the illustrated embodiment, exerts forces on the end portions of the rope strands tending to unwind, untwist or unwrap them from about the core.

Due to the helical wrapping of the strands about the core, forcing the ends of the strands in such a loosening direction L of a revolutionary path about the core tends to increases a length along the core which can be spanned by each strand. In other words, because the helical path of the strand extends both around and along the core, any selected length of the helical strand spans both axial and circumferential distances relative to the core, and so unwrapping the selected strand length from about the core frees up the portion of the selected length previously used to span circumferential distance, allowing this portion to now be stretched along the core instead. However, with the tool fitted over the end of the fixed-length core and the recesses being closed at the opposite face 22 of the tool body 12, the newfound increased length of each loosened strand obtained by circumferentially displacing the end of the strand in the loosening direction about the core end has no room to expand in a solely longitudinal manner along the portion of the core extending into the central recess of the tool body along the central axis 12A thereof, and thus is forced to instead expand outward away from the cores sliding the end of the strand along the respective one of the slots S1-S6 toward the outer end thereof.

In other words, the side walls 24 of the slots act as guiding surfaces, directing the ends of the strands outward away from the core of the wire rope under pivoting of the tool handle 14 to rotate the tool body 12 about the rope's core extending into the central recess 20 along the tool body's central axis 12A to effect untwisting of the strand ends from about the core.

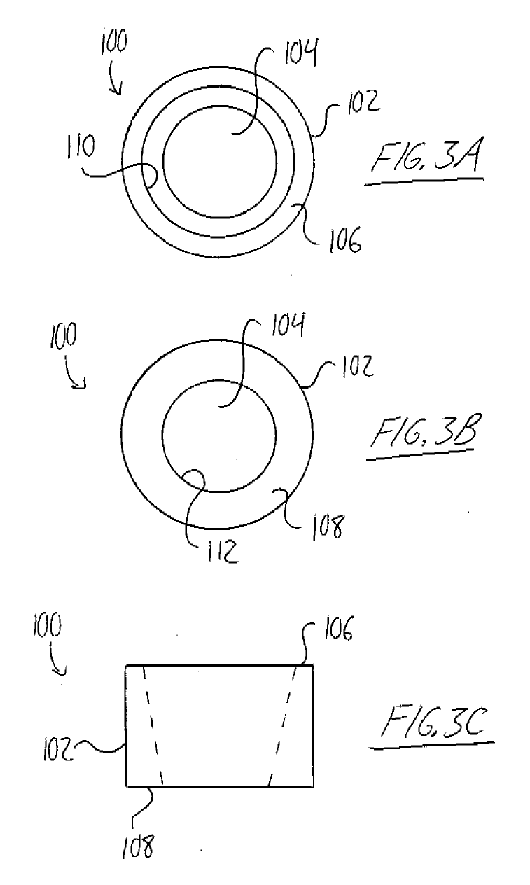

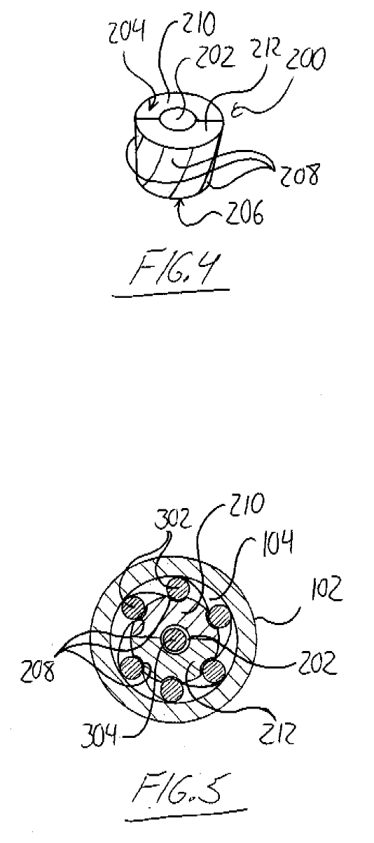

FIGS. 3 to 5 illustrate an application for which use of the tool is advantageous. FIGS. 3A-3C show a bell sleeve 100, conventionally used with a wedge, such as that shown in FIG. 4, to define a stop on a wire rope at an end thereof to prevent separation of the rope end from an element to which it is connected. The bell sleeve is cylindrical with a circular cross section defining a round outer periphery 102. A tapered or frustoconical through-bore 104 is defined through the bell sleeve 100 between two end faces 106, 108 between which the periphery 102 spans. The frustoconical bore 104 forms a large opening 110 at end face 106 and a small opening 112 at the opposite end face 108, the terms large and small being used to describe the openings relative to one another due to the tapered or frustoconical shape of the bore 104.

FIG. 4 shows a frustoconical wedge 200 having a cylindrical bore 202 extending therethrough between its two end faces 204, 206, the tapering angle of the frustoconical wedge 200 matching that of the through-bore 104 of the bell sleeve 100, but the diameters of the end faces 204, 206 between which the wedge 200 tapers being chosen to leave annular space between the wedge 200 and the inner periphery or bore wall of the bell sleeve 100 when the wedge is concentrically lowered thereinto.

As shown in FIG. 5, the end of a wire rope is fed through the bore 102 of the bell sleeve 100 from the small opening 112 onward through the large opening 110 to dispose the bell sleeve around the rope. The strands 302 of the wire rope are splayed outward away from the central core 304 about which they were previously positioned in contact therewith using the tool 10 described herein above. With the ends of the strands 302 so splayed outward from the core 304 and tool subsequently removed from the end of the wire rope, the wedge 200 is inserted into the rope end in the newly formed space between the core 304 and the outer strands 302. As illustrated in FIG. 4 and known in the art, the wedge 200 may feature equally spaced apart grooves 208 in its outer periphery, each extending from end face 204 to end face 206 and corresponding to a respective strand of the wire rope, and may be formed by two shell-like halves 210, 212 arranged to fit together to define the frustoconical structure having a central opening or bore therethrough. As the illustrated tool embodiment is arranged for use with a six-strand wire rope, the illustrated wedge 200 features six grooves 208 spaced about its periphery when assembled, each of the halves 210, 212 of the two-piece wedge feature three such grooves. As shown in FIG. 5, with the core 304 of the rope extending through the central bore 202 of the wedge an each splayed strand 302 sitting in and extending along a respective groove in the wedge periphery, the bell sleeve 100 is pulled along the wire rope toward the wedge-equipped end thereof. The bell sleeve's frustoconical bore 104 allows it to be pulled over the wedge 200, the splayed strands 302 of the wire rope being clamped between the inner periphery of the bell sleeve 100 and the grooved outer periphery of the wedge 200, the size of the small opening in the bell sleeve 100 being chosen to prevent withdrawal of the bell sleeve of the end of the rope past the wedge and the wire strands disposed thereabout.

Compared to conventional methods of splaying cable ends, such as individually prying the ends of the strands outward from the core using a flathead screwdriver or other thin body as a lever, not only does use of the illustrated tool embodiment allow relatively quick and easy splaying of the wire rope strands due to the simultaneous splaying effect on all the strands under a single pivoting/rotating action, but it situates the strand ends in an evenly spaced fashion about the core due to the even spacing of the outer ends of the slots about the central recess, for example to fit the evenly spaced grooves of a conventional grooved wedge. The fitting of the tool over the cable end being splayed also improves on safety by reducing the likelihood of getting strands of steel wire embedded in one's hand. The positions of the outer end of each slot forward of the inner end thereof in the common direction C opposite the loosening direction L in which tool body is rotated to effect splaying of the strands reduces the circumferential distance about the central axis by which the strand ends are displaced during loosening relative to alternate embodiments in which both ends of each slot lie in the same radial plane relative to the central axis through the central recess. The shaping of each slots along a curved, arcuate or spiral path in the illustrated embodiment is chosen to better follow the twist of the cable compared to a straight or linear path between the ends of a slot, to encourage smooth outward motion of the wire rope strands in a more uniform manner.

Furthermore, it should be appreciated that after installing the wedge 200 into the splayed end of the wire rope, the tool may be used to tighten the splayed strands around the wedge. The strand and core ends are reinserted into the central recess and slot recesses respectively, but now with the strand ends fitting into the outer end portions S1o-S6o of the slots S1-S6, not the inner end portions. The tool body 12 is once again rotated about the rope core received in the central recess 20, but this time in an opposite direction T tending to tighten the strands about the core and the now surrounding wedge, direction T matching common direction C in which the outer ends of the slots lead the inner ends of the slots around the central recess 20. The movement of the strand ends along a revolutionary path in this tightening direction causing an effective shortening of the strands along the core due to re-wrapping of them circumferentially around the core that would occur in the absence of the wedge, the side walls 24 of the slots S1-S6 again acting as guide surfaces, but this time guiding the ends of the strands inward back toward the core under their effective shortening along the core.

Turning of the illustrated tool embodiment in one direction spreads the strands of a cable away from the center core to allow the wedge pieces to be set in place, with subsequent turning of the tool in the opposite direction tightening the strands onto the wedge in an equal and uniform manner, to allow the bell sleeve to relatively easily and quickly slid onto the wedges and cable.

It should be appreciated that the tool body need not necessarily be cylindrical or a solid body spanning fully between the working face and opposite side of the body to rigidly fill the space between the slots. For example, the slots may be formed by curved walls projecting from a flat disc-like carrying body defining the closed ends of the slots. However, the solid body construction improves the strength and durability of the tool. Furthermore, a lever like handle need not necessarily be provided, but such an arrangement improves the ease with which the tool body can be rotated to splay the wire rope ends. Furthermore, the central recess need not necessarily be located centrally on the tool body, although this provides a pleasant appearance and a well balanced feel during use.

The illustrated embodiment is for use with right hand lay wire rope. Alternate embodiments for left hand lay wire rope feature similar structure, but with the common direction C in which the outer ends of the slots lead the respective inner ends, the loosening or splaying direction L and the tightening direction T each being reversed from that shown and described in the illustrated right hand lay embodiment.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A tool for splaying strands of a wire rope at an end thereof outward away from a core of the rope about which the strands are disposed, the tool comprising:
a body defining a central opening and a plurality of outer openings extending into the body from a common side thereof, the central opening and the plurality of outer openings being sized and positioned for receipt of end portions of the central and strands at the end of the wire rope from the common side of the body, the outer openings each having an elongate shape extending outward away from the central opening along the common side of the body from an inner end to an outer end.

2. The tool according to claim 1 wherein the elongate shapes of the outer openings along the common side of the body deviate from radial directions relative to the central opening to situate the outer end of each outer opening ahead of the inner end thereof in a common direction about the central opening.

3. The tool according to claim 2 wherein sides of the elongate shape of each outer opening extending between the inner and outer ends thereof are curved.

4. The tool according to claim 2 wherein the elongate shape of each outer opening is smoothly curved from the inner end of the outer opening to the inner end thereof.

5. The tool according to claim 2 wherein sides of the elongate shape of each outer opening extending between the inner and outer ends thereof are concave to the common direction about the central opening.

6. The tool according to claim 1 wherein the body is solid between the openings along the common side of the body.

7. The tool according to claim 1 wherein at least one of the openings is defined by a respective recess extending only partially through the body from the common side thereof.

8. The tool according to claim 1 wherein the outer openings are each defined by a respective recess extending only partially through the body from the common side thereof.

9. The tool according to claim 1 further comprising a handle projecting from the body along the common side thereof to define a lever by which the body can be rotated about the central opening.

10. The tool according to claim 1 wherein the outer ends of the outer openings are equally spaced about the central opening.

11. The tool according to claim 1 wherein the outer ends of the outer openings are each radially spaced from the central opening along the common side of the tool body by an equal amount.

12. The tool according to claim 1 wherein the outer openings consist of six openings equally spaced about the central opening.

13. A tool for splaying strands of a wire rope at an end thereof outward away from a core of the rope about which the strands are disposed, the tool comprising:
a body defining a central opening and a plurality of outer openings extending into the body from a common side thereof, the central opening and the plurality of outer openings being sized and positioned for receipt of end portions of the central and strands at the end of the wire rope from the common side of the body;
the outer openings being arranged for splaying of the strands of the rope outward away from the core thereof at the end of the wire rope under rotation of the body in a first direction about the core at the end of the wire rope subsequent to receipt of the core and the strands in the central and outer openings respectively.

14. The tool according to claim 13 wherein the outer openings are also arranged for directing the strands of the rope inward back toward the core thereof under rotation of the body in a second direction, opposite the first direction, about the core at the end of the wire rope subsequent to splaying of the strands.

15. The tool according to claim 13 wherein the outer openings each having an elongate shape extending outward away from the central opening along the common side of the body, the elongate shapes of the outer openings along the common side of the body deviating from radial directions relative to the central opening to situate an outer end of each outer opening ahead of an inner end thereof in a common direction about the central opening.

16. A method for splaying strands of a wire rope at an end thereof outward away from a core of the rope about which the strands are disposed, the method comprising simultaneously untwisting the strands from about the core in a first direction while forcing the strands outward away from the core at the end of the wire rope.

17. The method according to claim 16 comprising sliding the strands along guide surfaces shaped and positioned to force each strand away from the core at the end of the wire rope under untwisting of the strands from about the core in the first direction.

18. The method according to claim 16 further comprising releasing the strands and inserting a wedge into the end of the rope over the core into space formed between the core and the strands during the twisting and forcing outward of the strands.

19. The method according to claim 18 further comprising simultaneously twisting the strands about the core in a second direction opposite the first direction while forcing the strands inward back toward the core at the end of the wire rope.
